(19) United States
(12) Patent Application Publication
(10) Pub. No.: US 2026/0259104 A1
(43) Pub. Date: Sep. 3, 2026

(54) CORE POSITION MEASUREMENT METHOD AND CORE POSITION MEASUREMENT APPARATUS

(71) Applicant: SUMITOMO ELECTRIC INDUSTRIES, LTD., Osaka (JP)

(72) Inventors: Takemi HASEGAWA, Osaka (JP); Takahiro SUGANUMA, Osaka (JP); Shin SATO, Osaka (JP)

(21) Appl. No.: 19/163,911

(22) PCT Filed: Mar. 12, 2024
(86) PCT No.: PCT/JP2024/009641

§ 371 Date: Sep. 10, 2025

(30) Foreign Application Priority Data
Mar. 28, 2023 (JP) 2023-051229

(51) Int. Cl. G01M 11/08; G06T 1/00; G06T 7/507; G06T 7/60

(52) U.S. Cl. CPC G01M 11/088; G06T 1/0007; G06T 7/507; G06T 7/60

(57) ABSTRACT

In this core position measuring method, a feature quantity vector is calculated for each contour extracted from an end surface image, for each of a plurality of brightness threshold value candidates prepared in advance. A first set including first feature quantity vector candidates satisfying a structural condition of common cladding is generated. A brightness threshold value candidate corresponding to any of the first feature quantity vector candidates of the first set is selected as a first brightness threshold value for extracting a contour of the common cladding. A second set including second feature quantity vector candidates satisfying a structural condition of a plurality of cores is generated. A brightness threshold value candidate corresponding to any of the second feature quantity vector candidates of the second set is selected as a second brightness threshold value for extracting contours of the plurality of cores.

### TECHNICAL FIELD

The present disclosure relates to a core position measurement method and a core position apparatus for a multicore optical fiber (hereinafter referred to as “MCF”). This application claims priority based on Japanese Patent Application No. 2023-051229 filed on Mar. 28, 2023, the entire contents of which are incorporated herein by reference.

### BACKGROUND ART

An MCF is an optical fiber including a plurality of cores made of a glass material, a common cladding made of a glass material and surrounding the plurality of cores, and a resin layer covering the common cladding. Thus, when transmitting an optical signal through each of the cores of the MCF or measuring optical characteristics of each of the core, it is necessary to identify a target core from the plurality of cores included in the MCF. In a highly versatile method for core identification, the positions of a plurality of cores and a common cladding are optically measured by optically observing an end face of the MCF. As an optical observation method and apparatus applicable to the MCF, a method described in Patent Literature 1 is known. In the method of Patent Literature 1, an imaging device equipped with a mirror and a camera is directly faced to a fiber end face. In this configuration, illumination light input to a side of the fiber from an LED or the like is emitted from the fiber end face, and an image of the fiber end face is captured by the camera.

### CITATION LIST

### Patent Literature

PTL 1: International Publication No. WO 2013/077002

### SUMMARY OF INVENTION

A core position measurement method according to the present disclosure is a core position measurement method for measuring, from an end face image of an MCF including a plurality of cores and a common cladding surrounding the plurality of cores, relative positions of the plurality of cores with respect to the common cladding having a different brightness from the plurality of cores in the end face image, and includes a first step to a fifth step. In the first step, one or more contours extracted from the end face image using one of a plurality of brightness threshold value candidates are associated with each of the plurality of brightness threshold value candidates prepared in advance. Furthermore, in the first step, one or more feature vectors associated one-to-one with the one or more contours corresponding to the one brightness threshold value candidate are calculated. In the second step, a first set including one or more first feature vector candidates that are each a feature vector satisfying a structural condition of the common cladding among the one or more feature vectors calculated in the first step is generated. In the third step, for each of the one or more first feature vector candidates belonging to the first set, a distance from one first target feature point whose position is designated by one first feature vector candidate to each of first peripheral feature points whose positions are designated by remaining first feature vector candidates is calculated. Furthermore, in the third step, a brightness threshold value candidate corresponding to a first feature vector candidate having a maximum degree of coincidence of the position of the first target feature point with the first peripheral feature points among the plurality of brightness threshold value candidates is selected as a first brightness threshold value for extracting a contour of the common cladding. In the fourth step, a second set including second feature vector candidates that are each a feature vector satisfying a structural condition of the plurality of cores is generated from the one or more feature vectors calculated in the first step. In the fifth step, for each of the second feature vector candidates belonging to the second set, a distance from one second target feature point whose position is designated by one second feature vector candidate to each of second peripheral feature points whose positions are designated by remaining second feature vector candidates is calculated. Furthermore, in the fifth step, a brightness threshold value candidate corresponding to a second feature vector candidate having a maximum degree of coincidence of the position of the second target feature point with the second peripheral feature points among the plurality of brightness threshold value candidates is selected as a second brightness threshold value for extracting contours of the plurality of cores.

In the core position measurement method according to the present disclosure, each of the one or more feature vectors calculated in the first step is a position vector whose components are represented by a plurality of pieces of structural data converted into numerical form as features of a corresponding contour of the one or more contours. In addition, each of the first target feature point, the first peripheral feature points, the second target feature point, and the second peripheral feature points is defined as a point in an m-dimensional spatial coordinate system with an origin at each of start points of the one or more position vectors when the number of components of the feature vector is m, where m is an integer of 2 or more. The “degree of coincidence of the position” of the first target feature point is evaluated based on a coincidence score obtained by adding a decreasing function of the distance to each of the first peripheral feature points calculated for the first target feature point. The “degree of coincidence of the position” of the second target feature point is evaluated based on a coincidence score obtained by adding a decreasing function of the distance to each of the second peripheral feature points calculated for the second target feature point. Furthermore, in the core position measurement method of the present disclosure, the relative positions of the plurality of cores with respect to the common cladding are measured based on the structural data of the first feature vector candidate corresponding to the first brightness threshold value selected in the third step and the structural data of the second feature vector candidate corresponding to the second brightness threshold value selected in the fifth step.

### BRIEF DESCRIPTION OF THE DRAWINGS

FIG. 1 is a diagram showing a structure of an MCF to be measured and a structure of a core position measurement apparatus of the present disclosure.

FIG. 2 is a diagram showing end face images and brightness distributions of various measurement targets.

FIG. 3 is a flowchart illustrating an overall configuration of the core position measurement method of the present disclosure;

FIG. 4 is a flowchart illustrating each step of common cladding measurement and core measurement in the core position measurement method of the present disclosure.

FIG. 5 is a diagram showing a data structure and the like for supplementarily illustrating each step of the core position measurement method of the present disclosure.

FIG. 6 is a diagram illustrating an operation of the apparatus for performing a display processing shown in FIG. 3.

FIG. 7 shows images in which the measurement results obtained by the core position measurement method and the core position measurement apparatus of the present disclosure are superimposed on the end face images.

### DETAILED DESCRIPTION

### Problems to be Solved by Present Disclosure

The inventors have studied conventional techniques and found the following problems. In the method of Patent Literature 1, brightness and contrast of the common cladding and the plurality of cores in the MCF captured by the imaging device may fluctuate due to differences in coating color of the MCF, a refractive index profile, a variation in coating thickness, and the like. Since the fluctuation in brightness or contrast may make it difficult to identify each core from elements constituting the end face of the MCF, it is also difficult to automate the core identification.

The present disclosure provides a core position measurement method and a core position measurement apparatus that enable automatic identification of elements constituting an end face of an MCF and high-precision measurement of core positions in common cladding even when there are variations in brightness and contrast in the end face image of the MCF.

### Advantageous Effects of Present Disclosure

According to the core position measurement method and the core position measurement apparatus of the present disclosure, even when there are variations in brightness and contrast in the end face image of the MCF, it is possible to automatically identify the elements constituting the end face of the MCF and to measure the core positions in the common cladding with high precision.

### Description of Embodiments of Present Disclosure

First, the contents of embodiments of the present disclosure are listed and described individually.

The core position measurement method according to the present disclosure is: (1) A core position measurement method for measuring, from an end face image of an MCF including a plurality of cores and a common cladding surrounding the plurality of cores, relative positions of the plurality of cores with respect to the common cladding having a different brightness from the plurality of cores in the end face image, and including a first step to a fifth step. In the first step, one or more contours extracted from the end face image using one of a plurality of brightness threshold value candidates are associated with each of the plurality of brightness threshold value candidates prepared in advance. Furthermore, in the first step, one or more feature vectors associated one-to-one with the one or more contours corresponding to the one brightness threshold value candidate are calculated. In the second step, a first set including one or more first feature vector candidates that are each a feature vector satisfying a structural condition of the common cladding among the one or more feature vectors calculated in the first step is generated. In the third step, for each of the one or more first feature vector candidates belonging to the first set, a distance from one first target feature point whose position is designated by one first feature vector candidate to each of first peripheral feature points whose positions are designated by remaining first feature vector candidates is calculated. Furthermore, in the third step, a brightness threshold value candidate corresponding to a first feature vector candidate having a maximum degree of coincidence of the position of the first target feature point with the first peripheral feature points among the plurality of brightness threshold value candidates is selected as a first brightness threshold value for extracting a contour of the common cladding. In the fourth step, a second set including second feature vector candidates that are each a feature vector satisfying a structural condition of the plurality of cores is generated from the one or more feature vectors calculated in the first step. In the fifth step, for each of the second feature vector candidates belonging to the second set, a distance from one second target feature point whose position is designated by one second feature vector candidate to each of second peripheral feature points whose positions are designated by remaining second feature vector candidates is calculated. Furthermore, in the fifth step, a brightness threshold value candidate corresponding to a second feature vector candidate having a maximum degree of coincidence of the position of the second target feature point with the second peripheral feature points among the plurality of brightness threshold value candidates is selected as a second brightness threshold value for extracting contours of the plurality of cores.

In the core position measurement method according to the present disclosure, each of the one or more feature vectors calculated in the first step is a position vector whose components are represented by a plurality of pieces of structural data converted into numerical form as features of a corresponding contour of the one or more contours. In addition, each of the first target feature point, the first peripheral feature points, the second target feature point, and the second peripheral feature points is defined as a point in an m-dimensional spatial coordinate system with an origin at each of start points of the one or more position vectors when the number of components of the feature vectors is m, where m is an integer of 2 or more. For example, when a feature of the common cladding is defined by three types of numerical data, the feature vector for the common cladding is expressed as three vector components. In addition, when a feature of each of cores is defined by three types of numerical data in the MCF having M cores, the feature vector for the cores in the MCF is expressed by (3×M) vector components. Here, M is an integer of 2 or more. The “degree of coincidence of the position” of the first target feature point is evaluated based on a coincidence score obtained by adding a decreasing function of the distance to each of the first peripheral feature points calculated for the first target feature point. The “degree of coincidence of the position” of the second target feature point is evaluated based on a coincidence score obtained by adding a decreasing function of the distance to each of the second peripheral feature points calculated for the second target feature point. The decreasing function may be a reciprocal. The square of the reciprocal may be used as the decreasing function. Furthermore, in the core position measurement method of the present disclosure, the relative positions of the plurality of cores with respect to the common cladding are measured based on the structural data of the first feature vector candidate corresponding to the first brightness threshold value selected in the third step and the structural data of the second feature vector candidate corresponding to the second brightness threshold value selected in the fifth step.

With the above configuration, even when variations in brightness and contrast occur in the end face image of the MCF due to individual differences of the MCF to be observed or variations in incidence of illumination light, it is possible to automatically identify elements constituting the end face of the MCF and measure the core positions in the common cladding with high precision.

(2) In the above (1), a plurality of first brightness threshold value candidates for extracting the contour of the common cladding and a plurality of second brightness threshold value candidates for extracting the contours of the plurality of cores may be prepared as the plurality of brightness threshold value candidates. In this case, the first step may include the sixth step and the seventh step. In the sixth step, a feature vector to be selected in the second step is calculated for each of the plurality of first brightness threshold value candidates. In the seventh step, a feature vector to be selected in the fourth step is calculated for each of the plurality of second brightness threshold value candidates. Such a configuration is particularly effective when the end face image of the MCF includes defects such as brightness halation around the core, a bright spot present in the core, and a missing part of the image of the common cladding. That is, since the brightness threshold value candidates for extracting the contour of the common cladding and the brightness threshold value candidates for extracting the contours of the plurality of cores are prepared in advance, it is possible to narrow down the range of optimum brightness threshold value for each type of the end face constituent elements such as the common cladding and the plurality of cores, thereby enabling more precise selection of the brightness threshold value.

(3) In the above (1) or (2), at least one of a numerical value of the structural data of the first feature vector candidate corresponding to the first brightness threshold value, image data generated based on the structural data of the first feature vector candidate corresponding to the first brightness threshold value, a numerical value of the structural data of the second feature vector candidate corresponding to the second brightness threshold value, or image data generated based on the structural data of the second feature vector candidate corresponding to the second brightness threshold value may be displayed. With this configuration, the state of the end face of the MCF to be measured can be visually confirmed.

(4) In any one of the above (1) to (3), the plurality of brightness threshold value candidates may range from a maximum brightness to a minimum brightness of the end face image.

(5) In any one of the above (1) to (4), the plurality of pieces of structural data may include data related to at least one of a centroid position or a size of the corresponding contour on the end face image.

A core position measurement apparatus of the present disclosure includes: (6) a calculator configured to perform the core position measurement method according to any one of the above (1) to (5), and a memory storing in advance the plurality of brightness threshold value candidates and storing a correspondence table calculated by the calculator. The correspondence table includes a first correspondence table indicating a correspondence relationship between a first feature vector and a brightness threshold value candidate corresponding to the first feature vector, and a second correspondence table indicating a correspondence relationship between a second feature vector and a brightness threshold value candidate corresponding to the second feature vector. With this configuration, even when the brightness and contrast of the end face image of the MCF fluctuate due to individual differences of the MCF to be observed or variations in incidence of illumination light, it is possible to automatically identify the elements constituting the end face of the MCF and measure the core positions in the common cladding with high precision.

A core position measurement apparatus according to the present disclosure is: (7) a core position measurement apparatus for measuring, from an end face image of an MCF including a plurality of cores and a common cladding surrounding the plurality of cores, relative positions of the plurality of cores with respect to the common cladding having a different brightness from the plurality of cores in the end face image, and the core position measurement apparatus includes a memory and a calculator. The memory stores a plurality of brightness threshold value candidates. The calculator performs the first step to the fifth step and selects a first brightness threshold value for extracting a contour of the common cladding and a second brightness threshold value for extracting contours of the plurality of cores. In the first step, one or more contours extracted from the end face image using one brightness threshold value candidate are associated with each of the plurality of brightness threshold value candidates read from the memory. Furthermore, in the first step, one or more feature vectors associated one-to-one with the one or more contours corresponding to the one brightness threshold value candidate are calculated. In the second step, a first correspondence table indicating a correspondence relationship between one or more first feature vector candidates that are each a feature vector satisfying a structural condition of the common cladding among the one or more feature vectors calculated in the first step and a brightness threshold value candidate corresponding to each of the one or more first feature vector candidates among the plurality of brightness threshold value candidates is stored in the memory. In the third step, for each of the one or more first feature vector candidates in the first correspondence table, a distance from one first target feature point whose position is designated by one first feature vector candidate to each of the first peripheral feature points whose positions are designated by remaining first feature vector candidates is calculated. Furthermore, in the third step, a brightness threshold value candidate corresponding to a first feature vector candidate having a maximum degree of coincidence of the position of the first target feature point with the first peripheral feature points among the plurality of brightness threshold value candidates is selected as the first brightness threshold value. In the fourth step, a second correspondence table indicating a correspondence relationship between second feature vector candidates that are each a feature vector satisfying a structural condition of the plurality of cores among the one or more feature vectors calculated in the first step and a brightness threshold value candidate corresponding to each of the second feature vector candidates among the plurality of brightness threshold value candidates is stored in the memory. In the fifth step, for each of the second feature vector candidates in the second correspondence table, a distance from one second target feature point whose position is designated by one second feature vector candidate to each of second peripheral feature points whose positions are designated by remaining second feature vector candidates is calculated. Furthermore, in the fifth step, a brightness threshold value candidate corresponding to a second feature vector candidate having a maximum degree of coincidence of the position of the second target feature point with the second peripheral feature points among the plurality of brightness threshold value candidates is selected as the second brightness threshold value.

In the core position measurement apparatus according to the present disclosure, each of the one or more feature vectors calculated in the first step is a position vector whose components are represented by a plurality of pieces of structural data converted into numerical form of a corresponding contour of the one or more contours. In addition, each of the first target feature point, the first peripheral feature points, the second target feature point, and the second peripheral feature points is defined as a point in an m-dimensional spatial coordinate system with an origin at each of start points of the one or more feature vectors when the number of components of the feature vector is m, where m is an integer of 2 or more. The degree of coincidence of the position of the first target feature point is evaluated based on a coincidence score obtained by adding a decreasing function of the distance to each of the first peripheral feature points calculated for the first target feature point. The degree of coincidence of the position of the second target feature point is evaluated based on a coincidence score obtained by adding a decreasing function of the distance to each of the second peripheral feature points calculated for the second target feature point. Furthermore, in the core position measurement apparatus according to the present disclosure, the calculator measures the relative positions of the plurality of cores with respect to the common cladding, based on the structural data constituting the first feature vector candidate corresponding to the first brightness threshold value selected in the third step and the structural data constituting the second feature vector candidate corresponding to the second brightness threshold value selected in the fifth step.

With the above configuration, even when variations in brightness and contrast occur in the end face image of the MCF due to individual differences of the MCF to be observed or variations in incidence of illumination light, the elements constituting the end face of the MCF can be automatically identified, and the core positions in the common cladding can be measured with high precision.

(8) In the above (7), the memory may store, as the plurality of brightness threshold value candidates, a plurality of first brightness threshold value candidates for extracting the contour of the common cladding and a plurality of second brightness threshold value candidates for extracting the contours of the plurality of cores. In this case, the calculator may perform a sixth step and a seventh step as the first step. In the sixth step, a feature vector to be selected in the second step is calculated for each of the plurality of first brightness threshold value candidates. In the seventh step, a feature vector to be selected in the fourth step is calculated for each of the plurality of second brightness threshold value candidates. Such a configuration is particularly effective when the end face image of the MCF includes defects such as brightness halation around the core, a bright spot present in the core, and a missing part of the image of the common cladding. Since the brightness threshold value candidates for extracting the contour of the common cladding and the brightness threshold value candidates for extracting the contours of the plurality of cores are prepared in advance, it is possible to narrow down the range of an optimum brightness threshold value for each type of the end face constituent element such as the common cladding and the plurality of cores, thereby enabling more precise selection of the brightness threshold value.

(9) In the above (7) or (8), the core position measurement apparatus according to the present disclosure may further include a monitor. At least one of a numerical value of the structural data of the first feature vector candidate corresponding to the first brightness threshold value, image data generated based on the structural data of the first feature vector candidate corresponding to the first brightness threshold value, a numerical value of the structural data of the second feature vector candidate corresponding to the second brightness threshold value, or image data generated based on the structural data of the second feature vector candidate corresponding to the second brightness threshold value is displayed on the monitor. With this configuration, the state of the end face of the MCF to be measured can be visually confirmed.

(10) In any one of the above (7) to (9), the plurality of brightness threshold value candidates may range from a maximum brightness to a minimum brightness of the end face image.

(11) In any one of the above (7) to (10), the plurality of pieces of structural data may include data related to at least one of a centroid position or a size of the corresponding contour on the end face image.

Each of the embodiments listed in the section of the Description of Embodiments of Present Disclosure is applicable to each of the remaining embodiments, or to all combinations of the remaining embodiments.

### Details of Embodiments of Present Disclosure

Specific examples of a core position measurement method and a core position measurement apparatus according to the present disclosure will be described in detail below with reference to the accompanying drawings. The present disclosure is not limited to these examples, and is defined by the scope of the claims, and is intended to include all modifications within the scope and meaning equivalent to the scope of the claims. In the description of the drawings, the same elements are denoted by the same reference numerals, and redundant description thereof will be omitted.

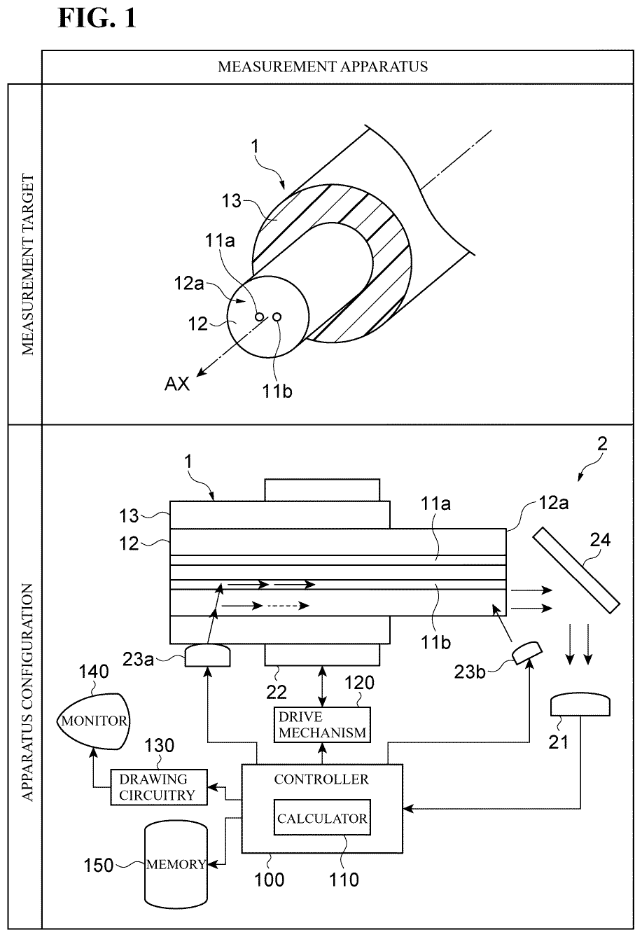

FIG. 1 is a diagram showing a structure of an MCF (multicore optical fiber) to be measured and a structure of a core position measurement apparatus of the present disclosure (denoted as “MEASUREMENT APPARATUS” in FIG. 1). In the upper part of FIG. 1 (denoted as “MEASUREMENT TARGET” in FIG. 1), the MCF that is a measurement target is shown. The lower part of FIG. 1 (denoted as “APPARATUS CONFIGURATION” in FIG. 1) shows a configuration example of the core position measurement apparatus of the present disclosure.

An MCF 1 shown in the upper part of FIG. 1 includes a glass optical fiber extending along a central axis (hereinafter denoted as “fiber axis AX”), and a resin covering 13 provided on the outer periphery of the glass optical fiber. The glass optical fiber includes an end face 12a, a first core 11a and a second core 11b each extending along the fiber axis AX, and a common cladding 12 surrounding each of the first core 11a and the second core 11b. An image of the end face 12a is captured to measure the core positions. When the end face 12a of the MCF 1 is observed, the resin covering 13 at a tip portion of the MCF 1 including the end face 12a is usually removed. In addition, an MCF having three or more cores and an MCF having a dummy core for the purpose of identification are also measurement targets of the core position measurement method and the core position measurement apparatus of the present disclosure. The above-described dummy core is also called a marker.

A core position measurement apparatus 2 shown in the lower part of FIG. 1 includes, as a configuration that enables the posture control of the MCF 1 having the above-described structure, a stage 22 for controlling the posture of the MCF 1 in a state where the MCF 1 is held, and a drive mechanism 120 that drives the stage 22. As a configuration for capturing an end face image of the MCF 1, the core position measurement apparatus 2 includes a lighting device 23a that outputs illumination light to a side of the MCF 1 through the resin covering 13, a lighting device 23b that outputs illumination light to a side of a tip portion of the MCF 1 from which a part of the resin covering 13 is removed, a mirror 24 that reflects illumination light emitted from the end face 12a of the MCF 1, and a camera 21 that captures an image of the end face 12a of the MCF 1 through the mirror 24. Furthermore, as a configuration for implementing the core position measurement method of the present disclosure, the core position measurement apparatus 2 includes a controller 100 including a calculator 110 that implements the core position measurement method of the present disclosure, a monitor 140, a drawing circuitry 130 that generates image data or the like to be displayed on the monitor 140, and a memory 150. The controller 100 controls peripheral devices such as the camera 21, the lighting device 23a, the lighting device 23b, the drive mechanism 120, the drawing circuitry 130, and the memory 150 as a whole.

In the core position measurement apparatus 2, first, illumination light is output from the lighting device 23a to the side of the MCF 1 through the resin covering 13, and illumination light is output from the lighting device 23b to the side of the tip portion of the MCF 1 from which a part of the resin covering 13 is removed. The output illumination light is a visible light with a wavelength of 0.4 μm to 0.7 μm or a near-infrared light with a wavelength of 0.7 μm to 2.2 μm. The near-infrared light is suitable for the illumination light because the near-infrared light is less likely to be scattered by scatterers in the colored resin covering 13 of the MCF 1 and a difference in the end face observation image due to the presence or absence of the coloring of the resin covering 13 is less likely to occur. A part of the illumination light output from the lighting device 23a is scattered inside the resin covering 13 and at the interface between the resin covering 13 and the common cladding 12, and propagates through each of the common cladding 12, the first core 11a, and the second core 11b of the MCF 1. The illumination light output from the lighting device 23b also propagates through each of the common cladding 12, the first core 11a, and the second core 11b of the MCF 1. As a result, the illumination light from the lighting device 23a and the lighting device 23b is emitted from the end face 12a of the MCF 1. The illumination light emitted from each of the common cladding 12, the first core 11a, and the second core 11b located on the end face 12a reaches the camera 21 via the mirror 24, and the image of the end face 12a is captured by the camera 21. Image data of the end face of the MCF 1 captured by the camera 21 is stored in the memory 150. The lighting device 23a may be disposed such that a portion of the MCF 1 closest to the lighting device 23a is separated from the end face 12a by 5 cm to 100 cm, or 10 cm to 50 cm. By making the illumination light incident on a portion of the MCF 1 sufficiently away from the end face 12a, a difference between a transmission loss of the illumination light transmitted through the cores and reaching the end face 12a and a transmission loss of the illumination light transmitted through the cladding and reaching the end face 12a becomes large. This makes it possible to maintain a high contrast between the cores and the cladding in the end face image captured by the camera 21, thereby enabling more reliable detection of the cores and the cladding. Although not shown in FIG. 1, the illumination light may be incident on an end face of the MCF 1 opposite to the end face 12a, which is away from the end face 12a by 20 cm to 20 m, or 50 cm to 10 m. This makes it possible to selectively increase the brightness of the cores, thereby enabling more reliably detection of the cores.

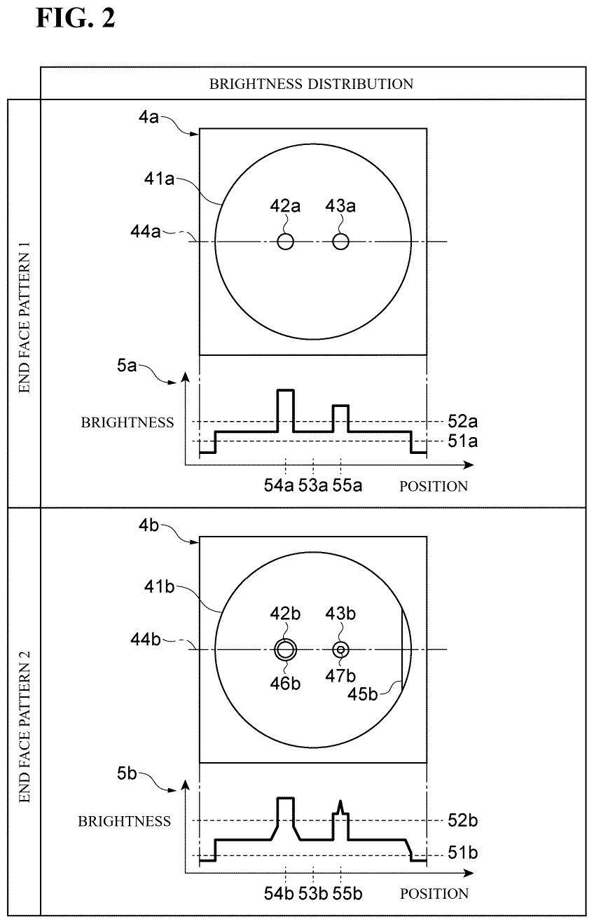

FIG. 2 is a diagram showing end face images and brightness distributions of various measurement targets (denoted as “BRIGHTNESS DISTRIBUTION” in FIG. 2). In the upper part of FIG. 2 (denoted as “END FACE PATTERN 1” in FIG. 2), an ideal end face image 4a and a brightness distribution 5a of the measurement target are shown. In the lower part of FIG. 2 (denoted as “END FACE PATTERN 2” in FIG. 2), an end face image 4b and a brightness distribution 5b of the measurement target including an unclear region are shown.

The ideal end face image 4a captured by the camera 21 includes a common cladding image 41a, a first core image 42a, and a second core image 43a of the measurement target, as shown in the upper part of FIG. 2. The common cladding image 41a, the first core image 42a, and the second core image 43a are identified by a difference in brightness. The end face image 4a is stored in the memory 150 as image data. In order to explain this identification method, the brightness distribution 5a along a line image 44a passing through the center of the first core image 42a and the center of the second core image 43a is also shown in the upper part of FIG. 2. The line image 44a substantially means a one-dimensional pixel array on the monitor 140.

When an appropriate brightness threshold value 51a for extracting a contour of the common cladding image 41a is set, the contour of the common cladding image 41a is extracted by extracting pixels whose brightness changes at the brightness threshold value 51a as a boundary from the end face image 4a. As shown in FIG. 2, when the brightness of each of the first core image 42a and the second core image 43a is higher than the brightness of the common cladding image 41a, not only the contour of the common cladding image 41a but also the contour of each of the first core image 42a and the second core image 43a is extracted from the end face image 4a. The coordinates of a common cladding center 53a on the monitor 140 are calculated as the centroid of the region surrounded by the contour of the common cladding image 41a. Next, when an appropriate brightness threshold value 52a for extracting a contour of each of the first core image 42a and the second core image 43a is set, the contour of each of the first core image 42a and the second core image 43a is extracted by extracting pixels whose brightness changes at the brightness threshold value 52a as a boundary from the end face image 4a. By calculating the centroid of the region surrounded by the contour of each of the first core image 42a and the second core image 43a, the coordinates of a first core center 54a and a second core center 55a on the monitor 140 are calculated. In the example of FIG. 2, the brightness of each of the first core image 42a and the second core image 43a is higher than the brightness of the common cladding image 41a. Thus, although the brightness threshold value 52a for core contour extraction is set higher than the brightness threshold value 51a for common cladding contour extraction, the magnitude relationship between the brightness and the brightness threshold value may be reversed depending on a manner in which illumination light is input.

As illustrated in the lower part of FIG. 2, the end face image 4b including the defects captured by the camera 21 includes defects such as a missing part 45b of the outer edge of a common cladding image 41b, a brightness halation 46b around a first core image 42b, and a bright spot 47b located inside a second core image 43b, in addition to the common cladding image 41b, the first core image 42b, and the second core image 43b which are the measurement targets. The end face image 4b is also stored in the memory 150 as image data. These defects can be reduced by a method of cutting the end face of the measurement target, a type of illumination, a method of inputting illumination light, and the like. However, in practice, some defects are unavoidable. For the purpose of explaining the identification method in this case, the brightness distribution 5b along a line image 44b passing through the center of the first core image 42b and the center of the second core image 43b is also shown in the lower part of FIG. 2. The line image 44b substantially means a one-dimensional pixel array on the monitor 140.

In the example shown in the lower part of FIG. 2, an appropriate brightness threshold value 51b is set for extracting a contour of the common cladding image 41b, and the coordinates of a common cladding center 53b on the monitor 140 are finally calculated. However, when the brightness threshold value 51b is substantially equal to the brightness of the missing part 45b, the contour of the extracted common cladding image 41b is affected by the missing part 45b and becomes inaccurate, and as a result, an error occurs in the calculated coordinates of the common cladding center 53b. Furthermore, by setting an appropriate brightness threshold value 52b for extracting a contour of each of the first core image 42b and the second core image 43b, the coordinates of a first core center 54b and a second core center 55b on the monitor 140 are finally calculated. However, when the brightness threshold value 52b is close to the brightness of the halation 46b or the brightness of the bright spot 47b, the extracted contour of each of the first core image 42b and the second core image 43b is affected by the halation 46b or the bright spot 47b and become inaccurate, and as a result, errors occur in the calculated coordinates of the first core center 54b and the second core center 55b on the monitor 140.

In the example in the lower part of FIG. 2, the brightness threshold value 51b and the brightness threshold value 52b for extracting the contour of each of the common cladding image 41b, the first core image 42b, and the second core image 43b are illustrated as appropriate levels that are not affected by the defects. However, in practice, the optimum brightness threshold value easily changes depending on the manner in which the defects are generated and the brightness distribution in the end face image of the measurement target. Thus, it has been difficult to mechanically set a brightness threshold value. This has led to a situation where an operator is involved in order to set an appropriate brightness threshold value, resulting in measurement errors due to human error and low efficiency in core position measurement.

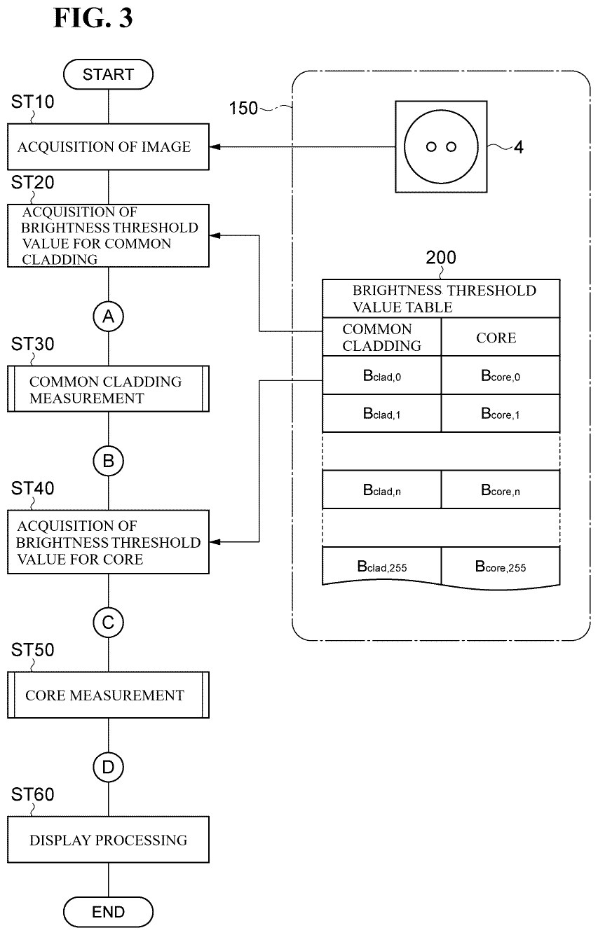

Next, the core position measurement method of the present disclosure using the core position measurement apparatus 2 shown in the lower part of FIG. 1 will be described in detail with reference to FIG. 3 to FIG. 7. The following description explain a case in which the MCF 1 shown in the upper part of FIG. 1 is the measurement target, and the common cladding measurement and the core measurement are performed using an end face image including defects such as the end face image 4b shown in the lower part of FIG. 2 as an end face image of the measurement target. Brightness threshold value candidates for extracting the contour of the common cladding and brightness threshold value candidates for extracting a contour of each of the plurality of cores are stored in the memory 150 in advance. When using the end face image including the defects as described above, the step of extracting the contour of the common cladding and the step of extracting the contour of each of the plurality of cores are separately performed. When the common cladding measurement and the core measurement are performed using the ideal end face image 4a, the brightness threshold value candidates stored in advance in the memory 150 do not need to be distinguished between the brightness threshold value candidates for extracting the contour of the common cladding and the brightness threshold value candidates for extracting the contour of each of the plurality of cores. In this manner, when the ideal end face image 4a is used, the contour extraction of the common cladding and the contour extraction of the plurality of cores may be performed in a single step. The core position measurement method of the present embodiment may be performed by using an apparatus other than the core position measurement apparatus 2 shown in the lower part of FIG. 1. For example, the camera 21 and the calculator 110 may be discrete devices separated from each other. The drive mechanism 120 does not have to be provided. When the drive mechanism 120 is not provided, the MCF 1 may be held on the fixed stage 22.

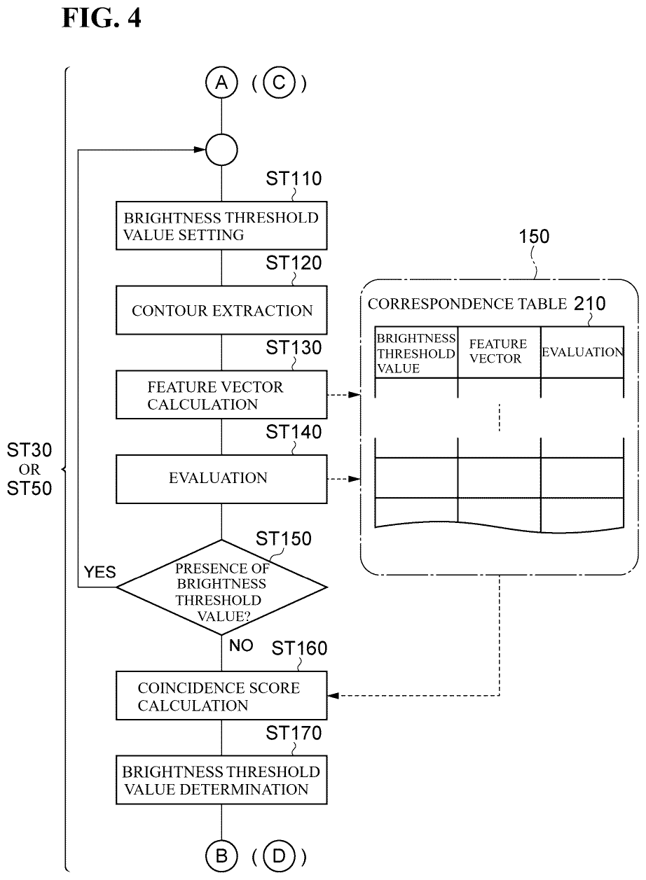

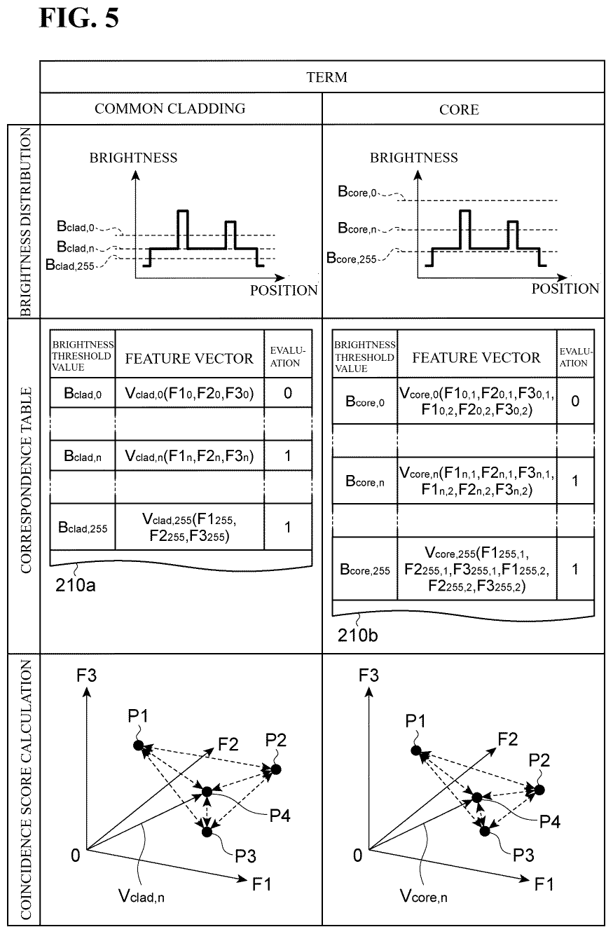

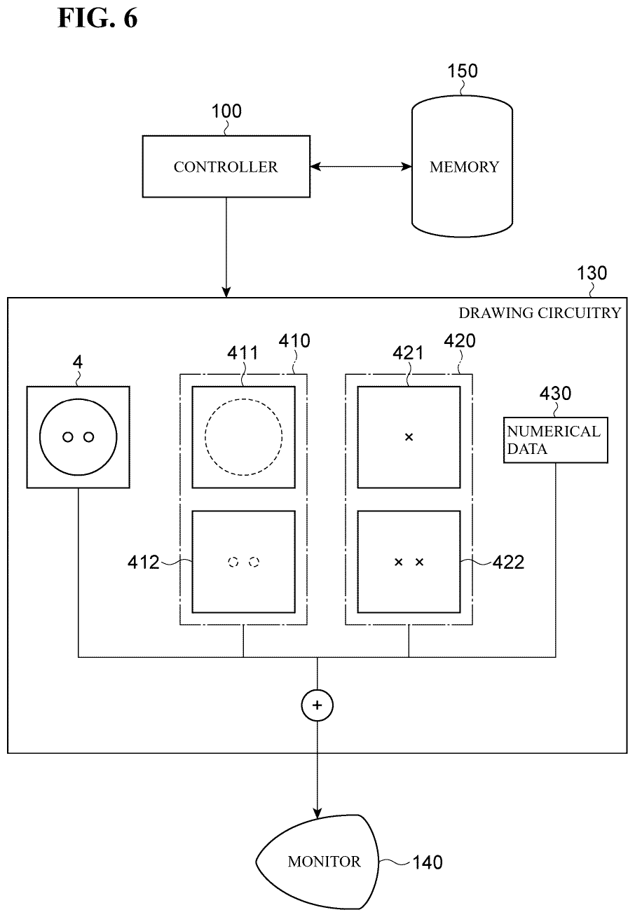

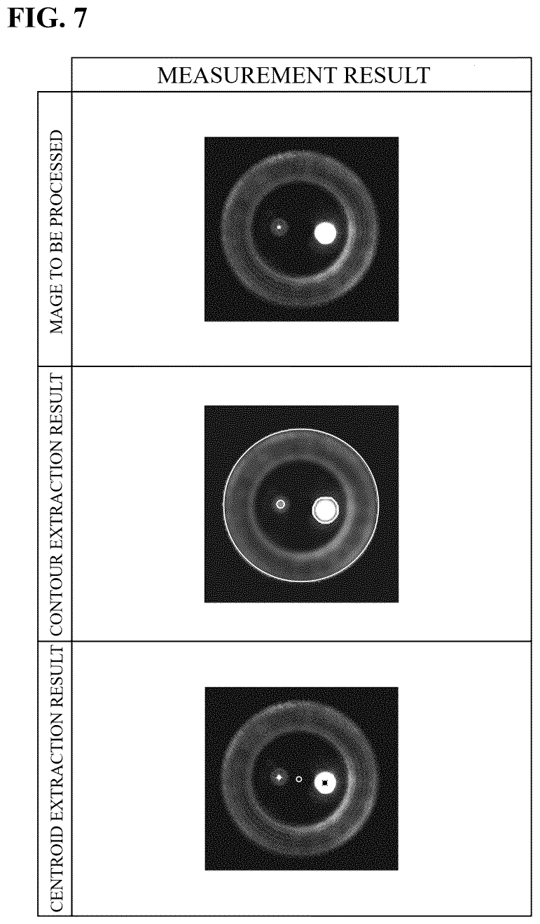

FIG. 3 is a flowchart illustrating an overall configuration of the core position measurement method of the present disclosure. FIG. 4 is a flowchart illustrating each step of a common cladding measurement and a core measurement in the core position measurement method of the present disclosure. FIG. 5 is a diagram showing a data structure and the like for supplementarily illustrating each step of the core position measurement method of the present disclosure (denoted as “TERM” in FIG. 5). FIG. 6 is a diagram illustrating an operation of the apparatus for performing a display processing shown in FIG. 3. FIG. 7 shows images in which the measurement results obtained by the core position measurement method and the core position measurement apparatus of the present disclosure are superimposed on the end face images (denoted as “MEASUREMENT RESULT” in FIG. 7).

A diagram for explaining terms related to the measurement of the common cladding of an MCF which is a measurement target in the core position measurement method of the present disclosure is shown on the left side of FIG. 5 (denoted as “COMMON CLADDING” in FIG. 5), and a diagram for explaining terms related to the measurement of the cores is shown on the right side of FIG. 5 (in FIG. 5, denoted as “CORE”). The upper part of FIG. 5 (denoted as “BRIGHTNESS DISTRIBUTION” in FIG. 5) shows the relationship between the brightness distribution and the brightness threshold value of each of the common cladding and the cores. In the middle part of FIG. 5 (denoted as “CORRESPONDENCE TABLE” in FIG. 5), a correspondence table indicating a relationship between a feature vector for each brightness threshold value and its evaluation is shown. The lower part of FIG. 5 (denoted as “COINCIDENCE SCORE CALCULATION” in FIG. 5) shows a diagram illustrating a method of calculating a brightness threshold value necessary for measurement. The end face image of the MCF to be measured is shown in the upper part of FIG. 7 (denoted as “IMAGE TO BE PROCESSED” in FIG. 7). In the middle part of FIG. 7 (denoted as “CONTOUR EXTRACTION RESULT” in FIG. 7), a diagram is shown in which the extracted contours of the common cladding and the cores are superimposed on the end face image shown in the upper part of FIG. 7. The lower part of FIG. 7 (denoted as “CENTROID EXTRACTION RESULT” in FIG. 7) shows a diagram in which the centroids of the extracted common cladding and core are superimposed on the end face image shown in the upper part of FIG. 7.

The entire operation of the core position measurement method of the present disclosure is performed by the calculator 110 according to the flowchart shown in FIG. 3, where the MCF 1 shown in the upper part of FIG. 1 is a measurement target and an end face image including defects such as the end face image 4b shown in the lower part of FIG. 2 is used. The peripheral devices such as the drawing circuitry 130 are entirely controlled by the controller 100.

In a step ST10, the calculator 110 acquires an end face image 4 of the measurement target stored in the memory 150. The end face image 4 is an end face image including defects. The memory 150 stores not only the end face image 4 captured in advance by the camera 21 but also a brightness threshold value table 200 in which brightness threshold values B_{clad,n} for extracting the contour of the common cladding 12 and brightness threshold values B_{core,n} for extracting the contour of each of the first core 11a and the second core 11b are recorded as brightness threshold value candidates. Specifically, 256 values from B_{clad,0} to B_{clad,255} are prepared as the brightness threshold values B_{clad,n}. Furthermore, as the brightness threshold values B_{core,n}, 256 values from B_{core,0} to B_{core,255} are prepared. Here, n is an integer of 0 to 255. The prepared brightness threshold values may ideally range from the maximum brightness to the minimum brightness of the end face image 4. In the example of FIG. 3, the brightness threshold values B_{clad,n} for extracting the contour of the common cladding 12 and the brightness threshold values B_{core,n} for extracting the contour of each of the first core 11a and the second core 11b are separately prepared. However, common brightness threshold values for extracting the contour of the common cladding 12 and the contour of each of the first core 11a and the second core 11b may be stored in the memory 150.

Subsequently, in a step ST20, the brightness threshold values B_{clad,n} for extracting the contour of the common cladding 12 are taken into the calculator 110 from the memory 150 as the brightness threshold value candidates, and in a step ST30, the calculator 110 determines an optimum brightness threshold value for the contour measurement of the common cladding 12.

Following the step ST30 of performing the contour measurement of the common cladding 12, in a step ST40, the brightness threshold values B_{core,n} for extracting the contour of each of the first core 11a and the second core 11b are taken into the calculator 110 from the memory 150 as brightness threshold value candidates. Then, in a step ST50, the calculator 110 determines an optimum brightness threshold value for the contour measurement of the common cladding 12.

Contour information of each part included in the end face image 4 is associated with each of the optimum brightness threshold values determined by the calculator 110 in the step ST30 and the step ST50 as the feature of the measurement target. The contour information is defined by a centroid position of the contour and a radius of the contour. More specifically, the radius of the contour is structural data corresponding to an average distance from a contour centroid to the contour. The coordinates of the contour centroid are two types of structural data defined by a distance in a horizontal direction from a reference point on the end face image 4 to the contour centroid and a distance in a vertical direction from the reference point to the contour centroid. In a step ST60, the controller 100 generates image data and the like based on the structural data, and the drawing circuitry 130 instructed by the controller 100 performs a display processing of displaying the generated image data and the like on the monitor 140.

Next, a step 30 of the common cladding measurement shown in FIG. 3 will be described with reference to the flowchart in FIG. 4. A step 50 of the core measurement shown in FIG. 3 is also performed according to the flowchart in FIG. 4.

In a step ST110, the calculator 110 sets one brightness threshold value read from the brightness threshold values stored in the memory 150 as a brightness threshold value candidate. In a step ST120, the calculator 110 extracts the contour of each part of the measurement target from the end face image 4 using the selected brightness threshold value candidate. The contour of each part is extracted as a set of pixels on the monitor 140 whose brightness changes at the selected brightness threshold value candidate as a boundary. Image processing techniques for removing noise by a method of averaging adjacent pixels on an image before extracting a contour, reducing the influence of noise by fitting an extracted contour to a known curve such as an arc, and the like are well known to those skilled in the art. By appropriately utilizing these techniques, the error in the contour can be reduced.

The feature of the extracted contour may be structural data related to at least one of the centroid position or the size of the contour on the monitor 140. For example, horizontal coordinate data of the contour centroid with reference to an arbitrary origin on the end face image 4 is set as a feature F1, vertical coordinate data of the contour centroid is set as a feature F2, and radius data of the contour is set as a feature F3. The horizontal coordinate data and the vertical coordinate data of the contour centroid are given values converted into distances based on the number of pixels displayed on the monitor 140. The radius data is given by a radius of a circle having the same area as the area enclosed by the contour. In addition, when a plurality of cores are included as in the MCF 1, median values of coordinates of a plurality of contour centroids may be applied to the coordinate data of the contour centroid. The radius of a circle circumscribed to the contour may be applied to the radius data instead of the radius of a circle having the same area as the area surrounded by the contour.

The calculator 110 performs contour extraction in the step ST120 using one brightness threshold value candidate, and then calculates a plurality of feature vectors V (F1, F2, F3) for one brightness threshold value candidate in a step ST130. This means that the contour of the common cladding 12 and the contour of each of the first core 11a and the second core 11b are extracted from the end face image 4 by using one brightness threshold value candidate, and a corresponding feature vector is calculated for each extracted contour.

In a step ST140, the calculator 110 selects a feature vector satisfying a structural condition of the common cladding 12 from the plurality of feature vectors calculated in step ST130 as a feature vector candidate associated with the contour of the common cladding 12, and finally, the calculator 110 creates a correspondence table 210 indicating a correspondence relationship between the selected feature vector candidate and the corresponding brightness threshold value candidate in the memory 150. The correspondence table 210 corresponds to a correspondence table 210a indicating a set of feature vector candidates for the contour of the common cladding 12 illustrated on the left side of the middle part in FIG. 5. The feature vector candidates calculated for the contour extraction of the common cladding 12 is expressed by V_{clad,n} (F1ₙ, F2ₙ, F3ₙ) when the feature vector candidate is associated with the n-th brightness threshold value candidate. Here, n is an integer of 0 to 255. As shown on the left side of the upper part in FIG. 5, for the brightness threshold values stored in advance in the memory 150, there is a case where the contour of the common cladding 12 itself cannot be extracted, or a case where the contour of an unnecessary portion is extracted in addition to the contour of the common cladding 12. Thus, in the step ST140, the calculator 110 evaluates a situation in which the feature vector candidate of the target portion has been successfully selected (denoted as “1” in Evaluation on the left side of the middle part in FIG. 5) and a situation in which the feature vector candidate has not been successfully selected (denoted as “0” in Evaluation on the left side of the middle part in FIG. 5), and the calculator 110 also records the evaluation result in the correspondence table 210 of the memory 150.

As a structural condition of the common cladding 12 used for selection in the step ST140, for example, when a condition that the common cladding 12 has a contour with the maximum size among contours extracted using the same brightness threshold value candidate is set, the contour of the common cladding 12 can be distinguished from the contour of each of the first core 11a and the second core 11b. In addition, since the shape of the common cladding is usually a circle or an ellipse, the structural condition may be that the degree of coincidence with a circle or an ellipse fitted to the contour is high. This reduces an error in which the brightness halation generated around the common cladding 12 is erroneously determined as the contour of the common cladding 12. Furthermore, when an approximate value of the radius of the cladding (typically, for example, 62.5 μm) is known, it may be a condition that the radius data of the contour is close to the known approximate value of the radius of the cladding.

In a step ST150, it is determined whether the operations from the step ST110 to the step ST140 have been performed for all the brightness threshold values stored in advance in the memory 150, and finally, the correspondence table 210a shown on the left side of the middle part in FIG. 5 is obtained.

Subsequently, in a step ST160, each of the feature vectors for which evaluation result is “1” among the feature vectors V_{clad,n} in the correspondence table 210a stored in the memory 150 becomes feature vector candidates to be used in determining a brightness threshold value in a step ST170. For example, when the feature vector is defined as a three-dimensional position vector in the step ST120 as described above, a feature point P1 to a feature point P4 whose positions are designated by the feature vector candidate are defined as points in the three-dimensional coordinate system as shown in the lower left of FIG. 5. In the calculation of the coincidence score for each feature vector candidate, for example, when the feature point P4 is set as the target feature point, a distance from the feature point P4 to each of the remaining peripheral feature points, which are the feature point P1, the feature point P2, and the feature point P3, are calculated. The coincidence score S_{clad} of the feature point P4 is given a value obtained by adding the respective reciprocals of the obtained distances. Instead of the reciprocal, for example, the square of the reciprocal may be used as the decreasing function. In this case, in order to allow each component of the feature vector to contribute to the processing result, a numerical value of each vector component may be of the same order of magnitude. More specifically, when a non-zero difference in the numerical values occurs between the vector components, the numerical values of the vector components may match within a range of a factor of 10. The feature point having the maximum coincidence score S_{clad} means a feature point having the maximum degree of coincidence of the position with other feature points, that is, a feature point closest to other feature points. This means that, in the optimum brightness threshold value for extracting the contour of the common cladding 12, even when the value thereof is changed, the change in the feature of the contour is small.

More specifically, for the contour of the common cladding 12, the coincidence score S_{clad} of the feature point P4 whose position is designated by the feature vector V_{clad,n}, which is the feature vector candidate corresponding to the n-th brightness threshold value, is given by the sum of the reciprocals of the distances from the feature point P4 to the feature points P1, P2, and P3 whose positions are each designated by the feature vector candidates that are the other candidates, as illustrated on the left side of the lower part in FIG. 5. As an example, when the coincidence score S_{clad} for the feature point P4 is calculated, first, a distance L1 from the feature point P4 whose position is designated by the feature vector candidate (a1, a2, a3) to the feature point P1 whose position is designated by the feature vector candidate (b1, b2, b3) is given by an equation of L1=((a1−b1)²+(a2−b2)²+(a3−b3)²)^{1/2}. In a similar manner, a distance from the feature point P4 to the feature point P2 is given by an equation for L2, and a distance from the feature point P4 to the feature point P3 is given by an equation for L3. Thus, the coincidence score S_{clad} of the feature point P4 is equal to (1/L1+1/L2+1/L3).

In the step 170, a brightness threshold value candidate corresponding to a feature vector candidate of a feature point having a maximum coincidence score among the feature vector candidates is selected as a brightness threshold value for extracting the contour of the common cladding 12. This makes it possible to mechanically set an optimum brightness threshold value for identifying the contour of the common cladding 12.

Next, the step 50 of the core measurement shown in FIG. 3 will be described with reference to the flowchart in FIG. 4.

In the step ST110, the calculator 110 sets one brightness threshold value read from the brightness threshold values stored in the memory 150 as a brightness threshold value candidate. In the step ST120, the calculator 110 extracts the contour of each part of the measurement target from the end face image 4 using the selected brightness threshold value candidate. The contour of each part is extracted as a set of pixels on the monitor 140 whose brightness changes at the selected brightness threshold value candidate as a boundary.

The feature of the extracted contour may be structural data related to at least one of the centroid position or the size of the contour on the monitor 140. For example, the horizontal coordinate data of the contour centroid with reference to an arbitrary origin on the end face image 4 is set as the feature F1, the vertical coordinate data of the contour centroid is set as the feature F2, and the radius data of the contour is set as the feature F3. The horizontal coordinate data and the vertical coordinate data of the contour centroid are given values converted into distances based on the number of pixels displayed on the monitor 140. The radius data is given by a radius of a circle having the same area as the area enclosed by the contour. In addition, when a plurality of cores are included as in the MCF 1, median values of coordinates of a plurality of contour centroids may be applied to the coordinate data of the contour centroid. The radius of a circle circumscribed to the contour may be applied to the radius data instead of the radius of a circle having the same area as the area surrounded by the contour.

The calculator 110 performs contour extraction of the step ST120 using one brightness threshold value candidate, and then calculates a plurality of feature vectors V (F1, F2, F3) for one brightness threshold value candidate in the step ST130. This means that the contour of the common cladding 12 and the contours of each of the first core 11a and the second core 11b are extracted from the end face image 4 by using one brightness threshold value candidate, and a corresponding feature vector is calculated for each extracted contour.

In the step ST140, the calculator 110 selects feature vectors satisfying the structural conditions of the first core 11a and the second core 11b from the feature vectors calculated in step ST130 as feature vector candidates associated with the respective contours of the first core 11a and the second core 11b. Finally, the calculator 110 creates the correspondence table 210 indicating a correspondence relationship between the selected feature vector candidates and the corresponding brightness threshold value candidates in the memory 150. The correspondence table 210 corresponds to a correspondence table 210b indicating a set of feature vector candidates for the contour of each of the first core 11a and the second core 11b illustrated on the right side of the middle part in FIG. 5. When the feature vector candidate calculated for the contour extraction of each of the first core 11a and the second core 11b is associated with the n-th brightness threshold value candidate, the feature vector candidate is expressed by V_{core,n} (F1_{n,1}, F2_{n,1}, F3_{n,1}, F1_{n,2}, F2_{n,2}, F3_{n,2}). Here, n is an integer of 0 to 255. As shown on the right side of the upper part in FIG. 5, for the brightness threshold values stored in advance in the memory 150, there may be a case where the contour of the first core 11a or the second core 11b themselves cannot be extracted, a case where only the contour of each of the first core 11a or the second core 11b can be extracted, or a case where the contour of an unnecessary portion is extracted in addition to the contour of each of the first core 11a and the second core 11b. Thus, in the step ST140, the calculator 110 evaluates a situation in which the feature vector candidate for the target portion has been successfully selected (denoted as “1” on the right side of the middle part in FIG. 5) and a situation in which the feature vector candidate has not been successfully selected (denoted as “0” on the right side of the middle stage in FIG. 5), and the calculator 110 also records the evaluation result in the correspondence table 210 of the memory 150.

As the structural condition of the first core 11a and the second core 11b used for selection in the step ST140, for example, when at least one of a condition that the distance from the center of the common cladding 12 is within a predetermined range or a condition that the area surrounded by the contour is within a predetermined range is set, the contour of each of the first core 11a and the second core 11b can be distinguished from the common cladding 12 or a bright spot due to noise. In addition, the structural condition of the cores may be that an interval between the centers of the first core 11a and the second core 11b, or an angle between line segments connecting the center of the common cladding 12 and each of the first core 11a and the second core 11b is within a predetermined range. This reduces an error in which the brightness unevenness in the common cladding 12 is erroneously determined as the contours of the first core 11a and the second core 11b.

In the step ST150, it is determined whether the operations from the step ST110 to the step ST140 have been performed for all the brightness threshold values stored in advance in the memory 150, and finally, the correspondence table 210b shown on the right side of the middle part in FIG. 5 is obtained.

Subsequently, in the step ST160, each of the feature vectors for which evaluation result is “1” among the feature vectors V_{core,n} in the correspondence table 210b stored in the memory 150 becomes feature vector candidates to be used in determining a brightness threshold value in the step ST170. For example, when the feature vector is defined as a (3×M)-dimensional position vector including features of M cores in the step ST120 as described above, the feature vector including the features of each of the first core 11a and the second core 11b is a six-dimensional position vector. Here, M is an integer of 2 or more. Thus, originally, the feature point whose position is designated by the feature vector candidate including the features of the first core 11a and the second core 11b is defined as a point in the six-dimensional coordinate system. On the right side of the lower part in FIG. 5, the feature point P1 to the feature point P4 whose positions are each designated by the feature vector candidates are indicated as points in the three-dimensional coordinate system in a simplified manner. In the calculation of the coincidence score for each feature vector candidate, for example, when the feature point P4 is set as the target feature point, distances from the feature point P4 to each of the remaining peripheral feature points, which are the feature point P1, the feature point P2, and the feature point P3, are calculated. The coincidence score S_{core} of the feature point P4 is given a value obtained by adding the respective reciprocals of the obtained distances. Instead of the reciprocal, for example, the square of the reciprocal may be used as the decreasing function. In this case, in order to allow each component of the feature vector to contribute to the processing result, a numerical value of each vector component may be of the same order of magnitude. More specifically, when a non-zero difference in the numerical values occurs between the vector components, the numerical values of the vector components may match within a range of a factor of 10. The feature point having the maximum coincidence score S_{core} means a feature point having the maximum degree of coincidence of the position with the other feature points, that is, a feature point closest to other feature points. This means that, in the optimum brightness threshold value for extracting the contour of each of the first core 11a and the second core 11b, even when the value thereof is changed, the change in the feature of the contour is small.

More specifically, for the contour of each of the first core 11a and the second core 11b in the MCF 1, the feature vector V_{core,n}, which is the feature vector candidate corresponding to the n-th brightness threshold value candidate, is expressed by, for example, (a11, a12, a13, a21, a22, a23). The coincidence score S_{core} of the feature point P4 whose position is designated by the feature vector candidate is given by the sum of the respective reciprocals of the distances from the feature point P4 to the feature points P1, P2, and P3 whose positions are each designated by the feature vector candidates that are other candidates. In the example shown on the right side of the lower part in FIG. 5, only the vector components of the feature related to one core are displayed. As an example, when the coincidence score S_{core} for the feature point P4 is calculated, first, a distance L1 from the feature vector candidate P4 whose position is designated by the feature vector candidate (a11, a12, a13, a21, a22, a23) to the feature point P1 whose position is designated by the feature vector candidate (b11, b12, b13, b21, b22, b23) is given by an equation of L1=((a11−b11)²+(a12−b12)²+(a13−b13)²+(a21−b21)²+(a22−b22)²+(a23−b23)²)^{1/2}. In a similar manner, a distance from the feature point P4 to the feature point P2 is given by L2, and a distance from the feature point P4 to the feature point P3 is given by L3. Thus, the coincidence score S_{clad} of the feature point P4 is equal to (1/L1+1/L2+1/L3).

In the step 170, a brightness threshold value candidate corresponding to a feature vector candidate of a feature point having a maximum coincidence score among the feature vector candidates is selected as a brightness threshold value for extracting the contour of each of the first core 11a and the second core 11b. This makes it possible to mechanically set an optimum brightness threshold value for identifying the contour of each of the first core 11a and the second core 11b.

When the optimum brightness threshold value for extracting the contour of the common cladding 12 and the optimum brightness threshold value for extracting the contour of each of the first core 11a and the second core 11b are set as described above, the display processing of the step 60 in FIG. 3 is performed. That is, since the determined brightness threshold values are associated with the feature vector V_{clad} and the feature vector V_{core}, image data is generated based on the structural data of feature vector V_{clad} and the structural data of feature vector V_{core}.

Specifically, as shown in FIG. 6, the controller 100 reads the structural data of the feature vector V_{clad} and the structural data of the feature vector V_{core} stored in the memory 150, and instructs the drawing circuitry 130 to generate the image data. The image data generated by the drawing circuitry 130 is, for example, the end face image 4, a contour data 410, a centroid data 420, a numerical data 430, and the like stored in the memory 150. The contour data 410 includes two-dimensional contour data 411 of the common cladding 12 and two-dimensional contour data 412 of the first core 11a and the second core 11b. The centroid data 420 includes two-dimensional centroid data 421 of the common cladding 12 and two-dimensional centroid data 422 of the first core 11a and the second core 11b. The controller 100 instructs the drawing circuitry 130 to display an image obtained by superimposing the contour data 410 on the end face image 4, an image obtained by superimposing the centroid data 420 on the end face image 4, or only the numerical data 430 on the monitor 140.

In the upper part of FIG. 7, an example of the end face image 4 to be processed is shown. An example of an image in which the contour data 410 is superimposed on the end face image 4 is shown in the middle part of FIG. 7. Furthermore, an example of an image in which the centroid data 420 is superimposed on the end face image 4 is shown in the lower part of FIG. 7. Even when the brightness of the region corresponding to the common cladding 12 is low, the brightness of the regions corresponding to the first core 11a and the second core 11b is high, and the brightness distribution is different between the first core 11a and the second core 11b as in the end face image 4 to be processed shown in the upper part of FIG. 7, the relative positions of the first core 11a and the second core 11b with respect to the common cladding 12 can be stably and mechanically calculated according to the core position measurement method of the present disclosure.

In addition, although an example of an apparatus for observing the end face of one MCF is shown in the lower part of FIG. 1, the core position measurement method of the present disclosure is also applicable to a fusion splicer that observes the end faces of two MCFs facing each other to measure the core positions of the MCFs and rotates the MCFs as appropriate to connect the MCFs so that the core positions are aligned with each other, as disclosed in Patent Literature 1.

### REFERENCE SIGNS LIST

1 MCF
11a first core
11b second core
12 common cladding
12a end face
13 resin covering
2 core position measurement apparatus
21 camera
22 stage
23a, 23b lighting device
24 mirror
100 controller
110 calculator
120 drive mechanism
130 drawing circuitry
140 monitor
150 memory
4, 4a, 4b end face image
41a, 41b common cladding image
42a, 42b first core image
43a, 43b second core image
44a, 44b line image
46b halation
47b bright spot
5a, 5b brightness distribution
51a, 51b, 52a, 52b brightness threshold value
53a, 53b common cladding center
54a, 54b first core center
55a, 55b second core center
200 brightness threshold value table
210, 210a, 210b correspondence table
410 contour data
411, 412 two-dimensional contour data
420 centroid data
421, 422 two-dimensional centroid data
430 numerical data
AX fiber axis

What is claimed is:

1. A core position measurement method for measuring, from an end face image of a multi-core optical fiber including a plurality of cores and a common cladding surrounding the plurality of cores, relative positions of the plurality of cores with respect to the common cladding having a different brightness from the plurality of cores in the end face image, the core position measurement method comprising:
a first step of associating, with each of a plurality of brightness threshold value candidates prepared in advance, one or more contours extracted from the end face image using one of the brightness threshold value candidates, and calculating one or more feature vectors associated one-to-one with the one or more contours corresponding to the one brightness threshold value candidate;
a second step of generating a first set including one or more first feature vector candidates, each of the one or more first feature vector candidates being a feature vector satisfying a structural condition of the common cladding among the one or more feature vectors calculated in the first step;
a third step of calculating, for each of the one or more first feature vector candidates belonging to the first set, a distance from one first target feature point whose position is designated by one first feature vector candidate to each of first peripheral feature points whose positions are designated by remaining first feature vector candidates, and selecting, as a first brightness threshold value for extracting a contour of the common cladding, a brightness threshold value candidate corresponding to a first feature vector candidate having a maximum degree of coincidence of the position of the first target feature point with the first peripheral feature points among the plurality of brightness threshold value candidates;
a fourth step of generating a second set including second feature vector candidates from the one or more feature vectors calculated in the first step, each of the second feature vector candidates being a feature vector satisfying a structural condition of the plurality of cores; and
a fifth step of calculating, for each of the second feature vector candidates belonging to the second set, a distance from one second target feature point whose position is designated by one second feature vector candidate to each of second peripheral feature points whose positions are designated by remaining second feature vector candidates, and selecting, as a second brightness threshold value for extracting contours of the plurality of cores, a brightness threshold value candidate corresponding to a second feature vector candidate having a maximum degree of coincidence of the position of the second target feature point with the second peripheral feature points among the plurality of brightness threshold value candidates, wherein
each of the one or more feature vectors calculated in the first step is a position vector whose components are represented by a plurality of pieces of structural data converted into numerical form as features of a corresponding contour of the one or more contours,
each of the first target feature point, the first peripheral feature points, the second target feature point, and the second peripheral feature points is defined as a point in an m-dimensional spatial coordinate system with an origin at each of start points of the one or more feature vectors, where m is an integer of 2 or more and the number of components of the feature vector is m,
the degree of coincidence of the position of the first target feature point is evaluated based on a coincidence score obtained by adding a decreasing function of the distance to each of the first peripheral feature points calculated for the first target feature point,
the degree of coincidence of the position of the second target feature point is evaluated based on a coincidence score obtained by adding a decreasing function of the distance to each of the second peripheral feature points calculated for the second target feature point, and
the relative positions of the plurality of cores with respect to the common cladding are measured based on the structural data of the first feature vector candidate corresponding to the first brightness threshold value selected in the third step and the structural data of the second feature vector candidate corresponding to the second brightness threshold value selected in the fifth step.

2. The core position measurement method according to claim 1, wherein
a plurality of first brightness threshold value candidates for extracting the contour of the common cladding and a plurality of second brightness threshold value candidates for extracting the contours of the plurality of cores are prepared as the plurality of brightness threshold value candidates, and
the first step includes:
a sixth step of calculating, for each of the plurality of first brightness threshold value candidates, a feature vector to be selected in the second step; and
a seventh step of calculating, for each of the plurality of second brightness threshold value candidates, a feature vector to be selected in the fourth step.

3. The core position measurement method according to claim 1, wherein
at least one of a numerical value of the structural data of the first feature vector candidate corresponding to the first brightness threshold value, image data generated based on the structural data of the first feature vector candidate corresponding to the first brightness threshold value, a numerical value of the structural data of the second feature vector candidate corresponding to the second brightness threshold value, or image data generated based on the structural data of the second feature vector candidate corresponding to the second brightness threshold value is displayed.

4. The core position measurement method according to claim 1, wherein
the plurality of brightness threshold value candidates range from a maximum brightness to a minimum brightness of the end face image.

5. The core position measurement method according to claim 1, wherein
the plurality of pieces of structural data include data related to at least one of a centroid position or a size of the corresponding contour on the end face image.

6. A core position measurement apparatus comprising:
a calculator configured to perform the core position measurement method according to claim 1; and
a memory storing in advance the plurality of brightness threshold value candidates, the memory storing a correspondence table calculated by the calculator, wherein
the correspondence table includes a first correspondence table indicating a correspondence relationship between the first feature vector candidate and a brightness threshold value candidate corresponding to the first feature vector candidate, and a second correspondence table indicating a correspondence relationship between a second feature vector candidate and a brightness threshold value candidate corresponding to the second feature vector candidate.

7. A core position measurement apparatus for measuring, from an end face image of a multi-core optical fiber including a plurality of cores and a common cladding surrounding the plurality of cores, relative positions of the plurality of cores with respect to the common cladding having a different brightness from the plurality of cores in the end face image, the core position measurement apparatus comprising:
a memory storing a plurality of brightness threshold value candidates; and
a calculator configured to select a first brightness threshold value for extracting a contour of the common cladding and a second brightness threshold value for extracting contours of the plurality of cores, wherein
the calculator is configured to perform:
a first step of associating, with each of the plurality of brightness threshold value candidates read from the memory, one or more contours extracted from the end face image using one brightness threshold value candidate, and calculating one or more feature vectors associated one-to-one with the one or more contours corresponding to the one brightness threshold value candidate;
a second step of storing a first correspondence table in the memory, the first correspondence table indicating a correspondence relationship between one or more first feature vector candidates and a brightness threshold value candidate corresponding to each of the one or more first feature vector candidates among the plurality of brightness threshold value candidates, each of the one or more first feature vector candidates being a feature vector satisfying a structural condition of the common cladding among the one or more feature vectors calculated in the first step;
a third step of calculating, for each of the one or more first feature vector candidates in the first correspondence table, a distance from one first target feature point whose position is designated by one first feature vector candidate to each of first peripheral feature points whose positions are designated by remaining first feature vector candidates, and selecting, as the first brightness threshold value, a brightness threshold value candidate corresponding to a first feature vector candidate having a maximum degree of coincidence of the position of the first target feature point with the first peripheral feature points among the plurality of brightness threshold value candidates;
a fourth step of storing a second correspondence table in the memory, the second correspondence table indicating a correspondence relationship between second feature vector candidates and a brightness threshold value candidate corresponding to each of the second feature vector candidates among the plurality of brightness threshold value candidates, each of the second feature vector candidates being a feature vector satisfying a structural condition of the plurality of cores among the one or more feature vectors calculated in the first step; and
a fifth step of calculating, for each of the second feature vector candidates in the second correspondence table, a distance from one second target feature point whose position is designated by one second feature vector candidate to each of second peripheral feature points whose positions are designated by remaining second feature vector candidates, and selecting, as the second brightness threshold value, a brightness threshold value candidate corresponding to a second feature vector candidate having a maximum degree of coincidence of the position of the second target feature point with the second peripheral feature points among the plurality of brightness threshold value candidates,
each of the one or more feature vectors calculated in the first step is a position vector whose components are represented by a plurality of pieces of structural data converted into numerical form as features of a corresponding contour of the one or more contours,
each of the first target feature point, the first peripheral feature points, the second target feature point, and the second peripheral feature points is defined as a point in an m-dimensional spatial coordinate system with an origin at each of start points of the one or more feature vectors, where m is an integer of 2 or more and the number of components of the feature vector is m,
the degree of coincidence of the position of the first target feature point is evaluated based on a coincidence score obtained by adding a decreasing function of the distance to each of the first peripheral feature points calculated for the first target feature point,
the degree of coincidence of the position of the second target feature point is evaluated based on a coincidence score obtained by adding a decreasing function of the distance to each of the second peripheral feature points calculated for the second target feature point, and
the calculator is configured to
measure the relative positions of the plurality of cores with respect to the common cladding, based on the structural data constituting the first feature vector candidate corresponding to the first brightness threshold value selected in the third step and the structural data constituting the second feature vector candidate corresponding to the second brightness threshold value selected in the fifth step.

8. The core position measurement apparatus according to claim 7, wherein
the memory stores, as the plurality of brightness threshold value candidates, a plurality of first brightness threshold value candidates for extracting the contour of the common cladding and a plurality of second brightness threshold value candidates for extracting the contours of the plurality of cores, and
the calculator is configured to perform, as the first step:
a sixth step of calculating, for each of the plurality of first brightness threshold value candidates, a feature vector to be selected in the second step; and
a seventh step of calculating, for each of the plurality of second brightness threshold value candidates, a feature vector to be selected in the fourth step.

9. The core position measurement apparatus according to claim 7, further comprising
a monitor configured to display at least one of a numerical value of the structural data of the first feature vector candidate corresponding to the first brightness threshold value, image data generated based on the structural data of the first feature vector candidate corresponding to the first brightness threshold value, a numerical value of the structural data of the second feature vector candidate corresponding to the second brightness threshold value, or image data generated based on the structural data of the second feature vector candidate corresponding to the second brightness threshold value.

10. The core position measurement apparatus according to claim 7, wherein
the plurality of brightness threshold value candidates range from a maximum brightness to a minimum brightness of the end face image.

11. The core position measurement apparatus according to claim 7, wherein
the plurality of pieces of structural data include data related to at least one of a centroid position or a size of the corresponding contour on the end face image.
